(19) United States
(12) Patent Application Publication
(10) Pub. No.: US 2008/0157647 A1
(43) Pub. Date: Jul. 3, 2008

(54) Field emission display device

(75) Inventors: Tzung-Han Yang, Taipei (TW); Yung-Chih Yu, Taipei (TW); Hung-Yuan Li, Taipei (TW)

Correspondence Address: BACON & THOMAS, PLLC, 625 SLATERS LANE, FOURTH FLOOR, ALEXANDRIA, VA, 22314, US

(73) Assignee: Tatung Company, Taipei (TW)

(21) Appl. No.: 11/826,784

(22) Filed: Jul. 18, 2007

(30) Foreign Application Priority Data
Dec. 29, 2006 (TW) 095149937

(51) Int. Cl. H01J 1/62

(52) U.S. Cl. 313/495

(57) ABSTRACT

A field emission display device (FED) is disclosed. The FED disclosed herein includes: a upper substrate, an anode layer, a phosphor layer, a lower substrate, at least one cathode, at least one electron emitter, and an partition plate set located between the upper substrate and the lower substrate. The partition plate set includes at least one nonmetal dielectric plate having plural holes, at least one insulation layer, and at least one gate. The FED of the present invention can simplify the process and reduce the damage caused by the manufacturing process, effectively increase the number of the electrons bombarding the phosphor layer, and increase the brightness and contrast ratio of the pixels.

### BACKGROUND OF THE INVENTION

1. Field of the Invention

The present invention relates to a field emission display device and, more particularly, to a field emission display device utilizing a dielectric plate as a partition plate set subject.

2. Description of Related Art

Currently, display devices are more and more important for daily life. In addition to computers and the Internet, TVs, cell phones, Personal Digital Assistants (PDAs), and vehicle information systems, etc., also need to be controlled to transmit signals by display devices. Based on factors of weight, volume, and health, the frequency for people to use flat panel display devices is higher and higher.

Among many novel technologies of display devices, field emission display devices (FEDs), which have a characteristic of high definition of picture tubes, are better than traditional liquid crystal display devices which have shortcomings of small visual angles, small range of use temperature, and low reactive speed. The FEDs have advantages of a higher product yield, a higher reactive speed, a better quality of display coordination, a brightness over 100 ftL, light and thin structures, a larger range of color temperature, a higher mobile efficiency, an easy recognition of tilt direction, and so forth.

In addition, because FEDs are active light-emitting display devices which need no back light modules in their structure, they can perform with excellent brightness even under outdoor sunlight. By development of nanotechnology, brand-new materials of electron emitters applied for FEDs are in great demand at present. Nanotubes which have a characteristic of point discharge, are used in FEDs to replace conventional electron emitters having weaknesses of short lifespan and difficulty in being manufactured. Therefore, FEDs are regarded as a novel technology to compete with or even replace LCDs.

The operation principle of FEDs similar to that of conventional cathode ray tubes (CRTs) is to emit, under a 10⁻⁶ torr vacuum, electrons from a cathode point in an electric field. In acceleration of the positive voltage of an anode plate, the electrons emitted from the cathode point bombard fluorescent powders on the anode plate, hence the fluorescent powders luminesce. Common FEDs are to control the potential change applied between a cathode and a gate, and then to emit electrons from every electron emitter at a determined time.

Structures of a cathode, insulation layers, electron emitters, and a gate in conventional FEDs are generally manufactured in a process for manufacturing a lower substrate. However, electron emitters can have lower quality after subsequent processes. Hence, to satisfy requirements of higher accuracy in FEDs, how to reduce destruction of electron emitters and to achieve protection of electron emitters are topics necessary to be overcome in the development of FEDs.

Therefore, an FED having a lower substrate manufactured by a simplified process is required at present, so as to reduce destruction and to achieve protection of electron emitters. Therefore, the above FEDs can have a promoted yield and potential for marketing competition.

### SUMMARY OF THE INVENTION

The object of the present invention is to provide a field emission display device, which features a gate structure forming on a partition plate set. Therefore, the purpose of simplifying the process of the lower substrate can be achieved through excluding the gate structure from the process of the lower substrate. Moreover, damage to electron emitters is decreased so as to protect the electron emitters. Hence, in the present invention, improvement in the field emission display device can result in better product yield.

Another object of the present invention is to provide a field emission display device, which features a dielectric plate used as a main component of a partition plate set.

Another object of the present invention is to provide a field emission display device, which features an electron amplification layer formed on the surface of the holes of the partition plate set. The efficiency of producing multiplicative second electrons can be increased. Additionally, through modulating the coefficient of producing second electrons of the electron amplification layer, the electronic amplification coefficient is modulated to 1, and the electrons are emitted uniformly.

In the present invention, a field emission display device includes an upper substrate, an anode layer, a phosphor layer, a lower substrate, at least one cathode, at least one electron emitter, and a partition plate set. In detail, the anode layer is formed on the surface of the upper substrate, and the phosphor layer is formed on the surface of the anode layer. Besides, the cathode is formed on the surface of the lower substrate, and the electron emitter is formed on the surface of the at least one cathode. Moreover, the partition plate set is placed between the upper substrate and the lower substrate, which comprises a gate, a first insulation layer, and a nonmetallic dielectric plate with plural holes.

In the present invention, the location of the gate can be formed in any position. Preferably, the gate of the present invention is formed on the lower surface of the nonmetallic dielectric plate, wherein the lower surface of the dielectric plate faces to the lower substrate. Besides, in the present invention, the relative position between the gate and the cathode is not limited. Preferably, the gate is nonparallel to the cathode. More preferably, the projection of the gate on the lower substrate is perpendicular to the cathode.

In the present invention, the location of the first insulation layer can be in any position. Preferably, the first insulation layer of the present invention is formed on the upper surface of the nonmetallic dielectric plate, wherein the upper surface of the dielectric plate faces to, the upper substrate. Moreover, the location of the electron emitter can be in any position. Preferably, the electron emitter corresponds to the holes of the nonmetallic dielectric plate. Additionally, the material of the electron emitter is not limited. Preferably, the electron emitter includes a carbon-containing compound, which is selected from the group consisting of graphite, diamond, diamond-like carbon, carbon nanotubes, C₆₀, and the combination thereof.

In the present invention, the components included in the field emission display device are not limited. Preferably, the field emission display device of the present invention further includes an electron amplification layer. In addition, the location of the electron amplification layer can be in any position in the present invention. Preferably, the electron amplification layer is formed on the surface of the holes of the partition plate set. More preferably, the electron amplification layer is formed on the surface of the holes of the partition plate set, and covers the surface of the gate. Otherwise, more preferably, the electron amplification layer is formed on the surface of the holes of the partition plate set, and covers the surface of the gate and the inside surface of the holes of the partition plate set. Most preferably, the electron amplification layer covers the whole surface of the holes of the partition plate set and the surface of the gate. Furthermore, the material of the electron amplification layer in the present invention is not limited. Preferably, the material of the electron amplification layer in the present invention is silver magnesium alloy, copper beryllium alloy, copper barium alloy, gold barium alloy, gold calcium alloy, wolfram barium gold alloy, or the combination thereof. Besides, the material of the electron amplification layer in the present invention is preferred to be beryllium oxide, magnesium oxide, calcium oxide, strontium oxide, barium oxide, or the combination thereof.

In the present invention, the components included in the partition plate set are not limited. Preferably, the partition plate set of the present invention further includes a second insulation layer. Additionally, the position of the second insulation layer in the present invention can be formed in any position. Preferably, the second insulation layer of the present invention is formed on the lower surface of the nonmetallic dielectric plate, wherein the lower surface of the dielectric plate faces to the lower substrate. Moreover, the components included in the upper substrate are not limited. Preferably, the upper substrate of the present invention further includes a black matrix layer. Besides, the position and the aspect of the black matrix layer in the present invention are not limited. Preferably, the black matrix layer of the present invention is patterned on the surface of the anode layer, and the phosphor layer is placed in the holes of the patterned black matrix layer. Furthermore, the material and the aspect of the cathode are not limited. Preferably, the cathodes are strip-like conductive materials.

In the present invention, the thickness of the dielectric plate is not limited. Preferably, the thickness of the dielectric plate in the present invention ranges between 300 μm and 5000 μm. In addition, the aspect of the holes of the dielectric plate is not limited. Preferably, the holes of the dielectric plate are arranged to form an M×N matrix graph, wherein M and N each independently is an integer greater than 0. Furthermore, the holes of the dielectric plate can be in any shape. Preferably, the holes of the dielectric plate in the present invention are in the shape of a tetragon, circle, polygon, ellipse, irregular shape, or the combination thereof.

In the present invention, the holes of the dielectric plate have a first openings facing to the upper substrate and a second openings facing to the lower substrate. The calibers of the first openings and the second openings are not limited. Preferably, the caliber of the first openings in the present invention is unequal to the caliber of the second openings. More preferably, the caliber of the first openings in the present invention is smaller than that of the second openings.

Besides, in the present invention, the calibers of the first openings and the second openings are not limited. Preferably, the calibers of the first openings and the second openings in the present invention range from 100 μm to 1000 μm. Additionally, the material of the dielectric plate in the present invention is not limited. Preferably, the material of the dielectric plate in the present invention is glass or ceramics. More preferably, the material of the dielectric plate in the present invention is silicon nitride, silicon oxide, sodium oxide, lithium oxide, lead oxide, boron oxide, or the combination thereof.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a field emission display device in a preferred embodiment of the present invention;

FIG. 2 is a perspective view of a part of a field emission display device in the preferred embodiment of the present invention;

FIG. 3 is a perspective view of a field emission display device in a preferred embodiment of the present invention;

FIG. 4 is a perspective view of a field emission display device in a preferred embodiment of the present invention;

FIG. 5 is a perspective view of a field emission display device in a preferred embodiment of the present invention; and

FIG. 6 is a perspective view of a field emission display device in a preferred embodiment of the present invention.

### DETAILED DESCRIPTION OF THE PREFERRED EMBODIMENT

By the following specific embodiments, the present invention is put into practice. One skilled in the art can easily understand other advantages and efficiency of the present invention through the disclosed content of the specification. Through other different embodiments, if any, the present invention can also be carried out or applied. In accordance with different observations and applications, all details of the specification can be modified and changed as not going against the spirit of the present invention.

### Embodiment 1

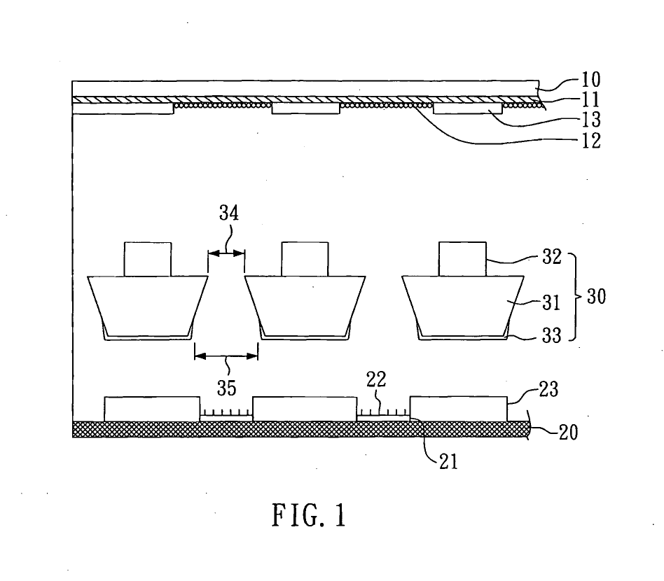

With reference to FIG. 1, there is a field emission display device in one preferred embodiment. The field emission display device includes an upper substrate 10, an anode layer 11, a phosphor layer 12, a black matrix layer 13, a lower substrate 20, and a partition plate set 30. In detail, the anode layer 11 is formed on the surface of the upper substrate 10, and the black matrix layer 13 is patterned and formed on the surface of the anode layer 11. Additionally, the phosphor layer 12 is formed on the surface of the anode layer 11, and deposited in the opening of the patterned black matrix layer 13. Besides, a cathode 21 is formed on the surface of the lower substrate 20, and the electron emitter 22 is formed on the surface of the cathode 21. A gate insulation layer 23 is formed on the surface of the lower substrate 20. Moreover, the partition plate set 30 is placed between the upper substrate 10 and the lower substrate 20, which comprises a gate 33, a first insulation layer 32, and a dielectric plate 31 with plural holes. In the partition plate set 30, the first insulation layer 32 is formed on the upper surface of the dielectric plate 31, and the upper surface faces to the upper substrate 10. The gate 33 is formed on the lower surface of the dielectric plate 31, and the lower surface faces to the lower substrate 20. The field emission display device of the present embodiment features in the gate 33 deposited on the partition plate set 30.

In detail, the dielectric plate 31 included in the partition plate set 30 can be made of glass or ceramics, and the thickness thereof ranges from 300 to 5000 μm. In the present embodiment, the provided dielectric plate 31 is a ceramic plate, and the thickness thereof is between 300 and 700 μm. Besides, the holes of the dielectric plate are arranged to form an M×N matrix graph, and N and M independently are integers greater than 0.

Moreover, the holes of the dielectric plate 31 can be in the shape of a quadrangle, a circle, a polygon, an ellipse, an irregular form, or the combination thereof. In the present invention, the holes of the dielectric plate 31 are in the shape of a circle. Additionally, the holes of the dielectric plate 31 have first openings 34 facing to the upper substrate 10 and second openings 35 facing to the lower substrate 20. The calibers of the first openings 34 and the second openings 35 are unequal to each other. In the present invention, the calibers of the first openings 34 and the second openings 35 are between 200 and 500 μm, and the caliber of the first openings 34 is smaller than that of the second openings 35.

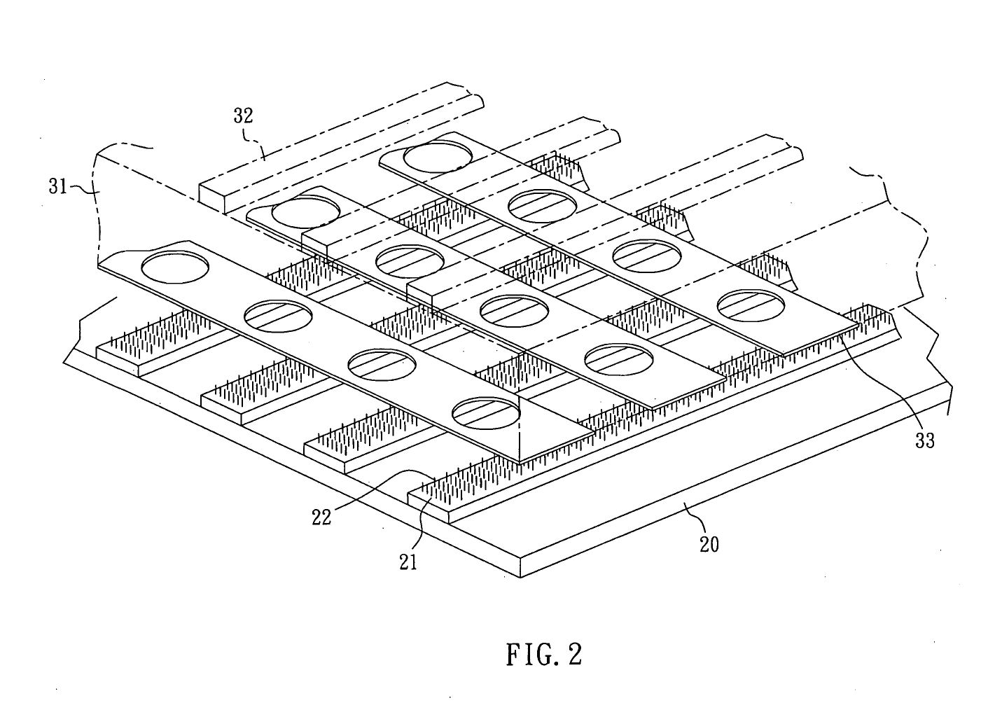

In addition, as shown in FIG. 2, the gate 33 and the cathode 21 are placed in unparallel arrangement, and, in the present embodiment, the projection of the gate 33 is perpendicular to the cathode 21. In the present embodiment, the cathode 21 is strip-like and made of a conductive material. Besides, the strip-like cathode 21 is in parallel arrangement on the upper surface of the lower substrate 20, and the electron emitters 22 are formed in dot distribution on the upper surface of the cathode 21. The electron emitters 22 correspond to the holes of the dielectric plate 31, and include a carbon-containing compound. Explicitly, the carbon-containing compound can be graphite, diamond, diamond-like carbon, nanotubes, C₆₀, or the combination thereof. In the present embodiment, the electron emitters 22 are nanotubes.

In the present embodiment, through manipulating potential change between the cathode 21 of the lower substrate 20 and the gate 33 of the partition plate set 33, FEDs can operate every electron emitter 22 to emit electrons at a determined time, and then control luminance time of every phosphor layer 12 corresponding to every electron emitter 22 on the upper substrate 10. Moreover, electrons emitted from the electron emitters 22 are affected by potential between the upper substrate 10 and the lower substrate 20, and then move in acceleration from the lower substrate 20 to the upper substrate 10. When the electrons bombard the phosphor layers 12 of the upper substrate 10, the electrons react with phosphor materials to produce visible light. The produced visible light will transmit over the transparent panel to outside, and then is detectable by the naked eye.

Furthermore, in the present invention, the upper substrate 10, the lower substrate 20, and the gate 33 can be manufactured by any method for manufacturing the upper substrate 10 and the lower substrate 20 of FEDs, for examples, screen printing, sand spraying, spray applying, sputtering, applying, photolithography, and etching, so that the FED having the structure of the present invention can be formed. Herein, the structure of the FED in the present embodiment can be manufactured by the simplified process of the lower substrate 20, so as to reduce destruction of the electron emitter 22 in subsequence processes and to obtain greater product yield.

### Embodiment 2

The FED structure of the present embodiment is similar to that of Embodiment 1, but the dielectric plate 31 of the present embodiment can be made of glass or ceramics, and also can be made of silicon nitride, silicon oxide, sodium oxide, lithium oxide, lead oxide, boron oxide, or the combination thereof. Explicitly, in the present embodiment, the dielectric plate 31 is made of silicon oxide.

### Embodiment 3

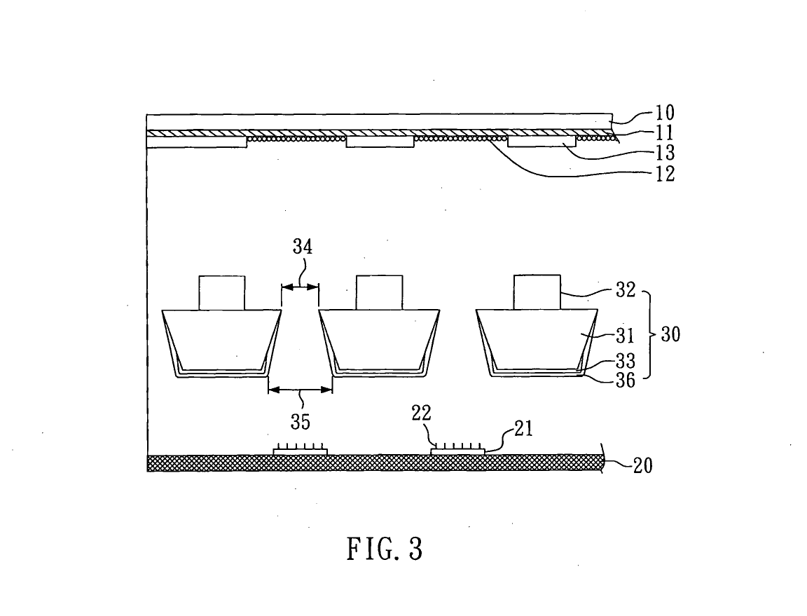

The FED structure of the present embodiment is similar to that of Embodiment 1, but the FED of the present embodiment further includes an electron amplification layer 36, and does not comprise a gate insulation layer 23. As shown in FIG. 3, the electron amplification layer 36 is formed on the surface of the gate 33 and covers on the hole inside of the partition plate set 31. Moreover, the electron amplification layer 36 can be made of silver magnesium alloy, copper beryllium alloy, copper barium alloy, gold barium alloy, gold calcium alloy, wolfram barium gold alloy, or the combination thereof. In the present embodiment, the electron amplification layer 36 is made of silver magnesium alloy.

In other words, on the surface of the gate 33 in the FED of the present embodiment, there are an electron amplification layer made of silver magnesium alloy and plural circular holes in matrix each corresponding to each of plural electron emitters 22 of the lower substrate 20. When electrons are applied with a bias voltage, they move from the lower substrate 20 to the upper substrate 10. The electrons pass through the partition plate set 30 and bombard electron amplification materials on the surface of the dielectric plate 31, so that secondary electrons increasing to multiple times are produced and the effect of the anode 12 of the upper substrate 10 to the electrode of the lower substrate 20 is isolated.

### Embodiment 4

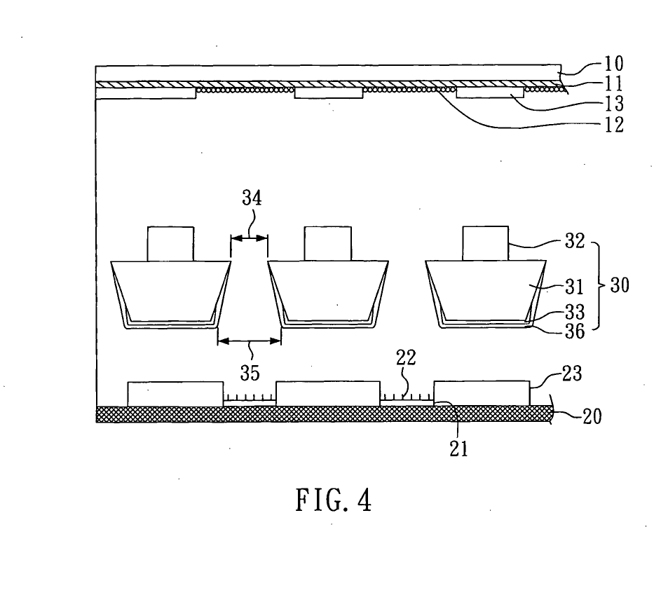

The FED structure of the present embodiment is similar to that of Embodiment 3, but the FED of the present embodiment further includes a gate insulation layer 23. As shown in FIG. 4, the gate insulation layer 23 is formed on the surface of the lower substrate 20.

### Embodiment 5

The FED structure of the present embodiment is similar to that of Embodiment 3, but the electron amplification layer 36 of the present embodiment can be made of beryllium oxide, magnesium oxide, calcium oxide, strontium oxide, barium oxide, or the combination thereof. In the present embodiment, the electron amplification layer 36 is made of magnesium oxide.

### Embodiment 6

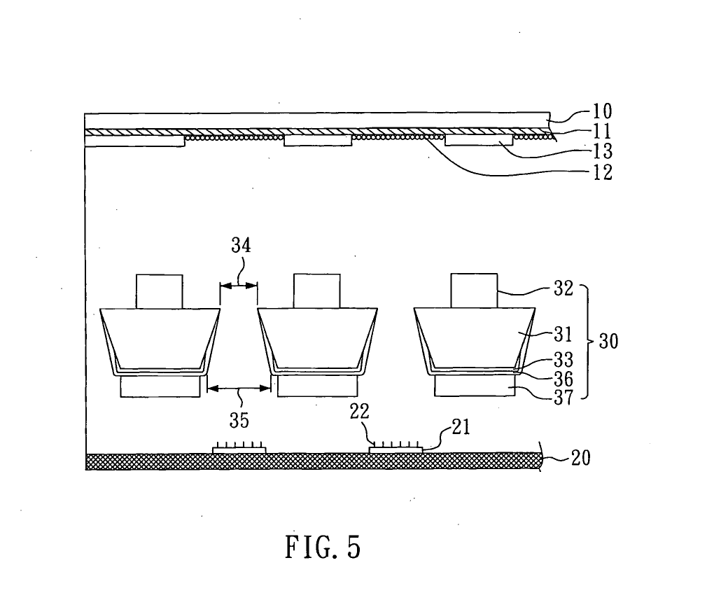

The FED structure of the present embodiment is similar to that of Embodiment 4, but the FED of the present embodiment further includes a second insulation layer 37. As shown in FIG. 5, the second insulation layer 37 is formed on the surface of the electron amplification layer 36. Additionally, with reference to FIG. 4 and FIG. 5, the object of depositing the second insulation layer 37 is known that the process of manufacturing the lower substrate is simplified through omitting the process of manufacturing the gate insulation layer 23 of the lower substrate 20. Besides, the second insulation layer 37 is made of insulating materials like aluminum oxide or silicon oxide.

### Embodiment 7

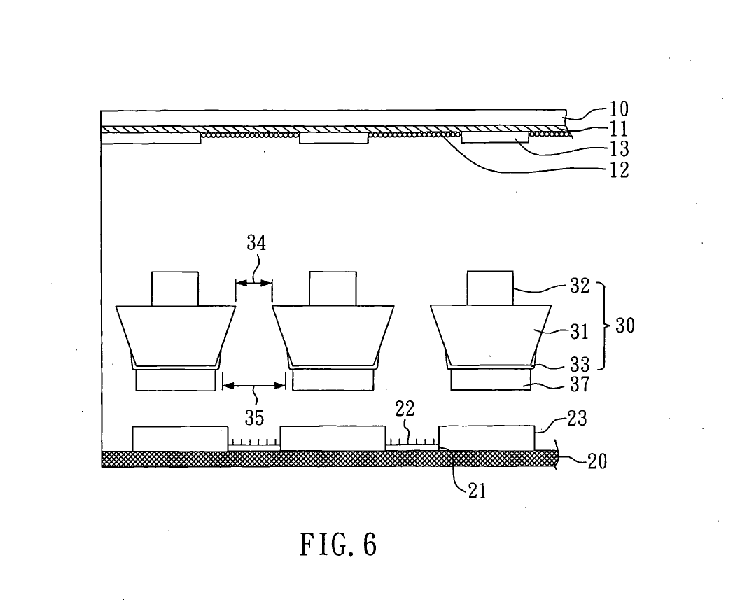

The FED structure of the present embodiment is similar to that of Embodiment 1, but the FED of the present embodiment further includes a second insulation layer 37. As shown in FIG. 6, the second insulation layer 37 is formed on a lower surface of the dielectric plate. The lower surface of the dielectric plate faces to the lower substrate.

In conclusion, the FED provided in the present invention is manufactured by a simplified process of the lower substrate 20. Additionally, the electron emitters 22 are protected from destruction in the subsequence processes. Hence, the FED of the present invention has greater product yield, and stands on a vantage point in the marketing competition.

Although the present invention has been explained in relation to its preferred embodiment, it is to be understood that many other possible modifications and variations can be made without departing from the scope of the invention as hereinafter claimed.

What is claimed is:

1. A field emission display device comprising:
an upper substrate;
an anode layer formed on the surface of the upper substrate;
a phosphor layer formed on the surface of the anode layer;
a lower substrate;
at least one cathode formed on the surface of the lower substrate;
at least one electron emitter formed on the surface of the at least one cathode; and
a partition plate set placed between the upper substrate and the lower substrate, which comprises at least one gate and a nonmetallic dielectric plate with plural holes.

2. The field emission display device as claimed in claim 1, wherein the at least one gate is formed on the lower surface of the nonmetallic dielectric plate, and the lower surface of the dielectric plate faces to the lower substrate.

3. The field emission display device as claimed in claim 1, wherein the at least one gate is nonparallel to the at least one cathode.

4. The field emission display device as claimed in claim 1, wherein the projection of the at least one gate on the lower substrate is perpendicular to the at least one cathode.

5. The field emission display device as claimed in claim 1, further comprising at least one first insulation layer, wherein the at least one first insulation layer is formed on the upper surface of the nonmetallic dielectric plate, and the upper surface of the dielectric plate faces to the upper substrate.

6. The field emission display device as claimed in claim 1, further comprising at least one second insulation layer, wherein the at least one second insulation layer is formed on the lower surface of the nonmetallic dielectric plate, and the lower surface of the dielectric plate faces to the lower substrate.

7. The field emission display device as claimed in claim 1, further comprising a gate insulation layer, which is formed on the surface of the lower substrate.

8. The field emission display device as claimed in claim 1, wherein the at least one electron emitter corresponds to the holes of the nonmetallic dielectric plate.

9. The field emission display device as claimed in claim 1, further comprising at least one electron amplification layer, which the at least one electron amplification layer is formed on the surface of the holes of the partition plate set.

10. The field emission display device as claimed in claim 1, further comprising at least one electron amplification layer, which the at least one electron amplification layer is formed on the inside of the holes of the partition plate set.

11. The field emission display device as claimed in claim 8, further comprising at least one second insulation layer, which is formed on the surface of the at least one electron amplification layer.

12. The field emission display device as claimed in claim 1, wherein the upper substrate further comprises a black matrix layer which is patterned on the surface of the anode layer, and the phosphor layer is placed in at least one hole of the patterned black matrix layer.

13. The field emission display device as claimed in claim 1, wherein the thickness of the dielectric plate ranges from 300 μm to 5000 μm.

14. The field emission display device as claimed in claim 1, wherein the holes of the dielectric plate are arranged to form an M×N matrix graph, and M and N each independently is an integer greater than 0.

15. The field emission display device as claimed in claim 1, wherein the holes of the dielectric plate are in a shape selected from the group consisting of tetragon, circle, polygon, ellipse, irregular shape, and the combination thereof.

16. The field emission display device as claimed in claim 1, wherein the holes of the dielectric plate have a first openings facing to the upper substrate and a second openings facing to the lower substrate, and the caliber of the first openings is unequal to that of the second openings.

17. The field emission display device as claimed in claim 13, wherein the caliber of the first openings is smaller than that of the second openings.

18. The field emission display device as claimed in claim 14, wherein the calibers of the first openings and the second openings range from 100 μm to 1000 μm.

19. The field emission display device as claimed in claim 1, wherein the material of the dielectric plate is glass or ceramics.

20. The field emission display device as claimed in claim 1, wherein the material of the dielectric plate is selected from the group consisting of silicon nitride, silicon oxide, sodium oxide, lithium oxide, lead oxide, boron oxide, and the combination thereof.

21. The field emission display device as claimed in claim 7, wherein the material of the at least one electron amplification layer is selected from the group consisting of silver magnesium alloy, copper beryllium alloy, copper barium alloy, gold barium alloy, gold calcium alloy, wolfram barium gold alloy, and the combination thereof.

22. The field emission display device as claimed in claim 7, wherein the material of the at least one electron amplification layer is selected from the group consisting of beryllium oxide, magnesium oxide, calcium oxide, strontium oxide, barium oxide, and the combination thereof.

23. The field emission display device as claimed in claim 1, wherein the cathodes are strip-like conductive materials.

24. The field emission display device as claimed in claim 1, wherein the electron emitter comprises a carbon-containing compound, which is selected from the group consisting of graphite, diamond, diamond-like carbon, carbon nanotubes, C₆₀, and the combination thereof.
